(19) United States
(12) Patent Application Publication
(10) Pub. No.: US 2009/0018905 A1
(43) Pub. Date: Jan. 15, 2009

(54) Power Puzzler

(76) Inventor: William Russell Roberts, Grayslake, IL (US)

Correspondence Address: William R. Roberts, 687 Alleghany Road, Grayslake, IL, 60030, US

(21) Appl. No.: 11/774,719

(22) Filed: Jul. 9, 2007

(51) Int. Cl. G06Q 30/00

(52) U.S. Cl. 705/14

(57) ABSTRACT

The current challenge in advertising is for internet advertisers and newspapers to get customers from the opposite media venue to use their product. Power Puzzler can draw newspaper readers to the internet, and also draw internet surfers to the newspaper. This unique usage of a standard crossword puzzle also has a unique capability that no other advertiser has been able to invent to date. It can advertise multiple businesses in one ad, while other advertisements are limited to one business at a time. The challenging puzzle draws the newspaper consumer to the Power Puzzler website for the solution to the puzzle. There, businesses gain additional exposure because each reference to the advertiser's business (slogan, logo, or company name) is a hyperlink to that advertiser's own website. Consumers are challenged by each puzzle to recall the advertisers' logo or slogan, and this achieves the goal of the puzzle—brand recognition.

### CROSS-REFERENCE TO RELATED APPLICATIONS

None

### STATEMENT REGARDING FEDERALLY SPONSORED RESEARCH OR DEVELOPMENT

Inventor is a small entity, and has no rights to inventions made under federally sponsored research and development.

### REFERENCE TO SEQUENCE LISTING, A TABLE, OR A COMPUTER PROGRAM LISTING COMPACT DISC APPENDIX

No sequence listing, table or computer program will be submitted in compact disc format.

### BACKGROUND OF THE INVENTION

This endeavor pertains to the advertising and marketing industries, and is designed to address the current challenge for advertisers in attracting customers from venues of information-gathering other than the one they habitually use. For instance, the diehard newspaper fan rarely visits the internet, and the avid surfer rarely delves into a daily periodical. Due to the current battle to draw customers from the newspaper to the web, and vice versa, this idea is the ideal method of attracting customers from both media, by offering popular entertainment, to the websites of those who choose to buy space from Power Puzzler.

### BRIEF SUMMARY OF THE INVENTION

Power Puzzler is a crossword puzzle whose clues and solutions are solely logos, slogans and company names of national businesses that choose to advertise with us. Power Puzzler will be placed in newspapers and magazines around the country. For the solution to each crossword puzzle, readers will be directed to the Power Puzzler website, where each reference to those who advertise with us will be hyperlinks to their website.

### BRIEF DESCRIPTION OF THE SEVERAL VIEWS OF THE DRAWING

The first picture

(FIG. 1) at the end of this specification shows Power Puzzler as it will appear in the newspaper.

FIG. 2 shows the clues that will be placed below the Power Puzzler grid.

FIG. 3 shows an image of how Power Puzzler will appear the following day in the newspaper(s) of publication, and on the www.powerpuzzler.com website.

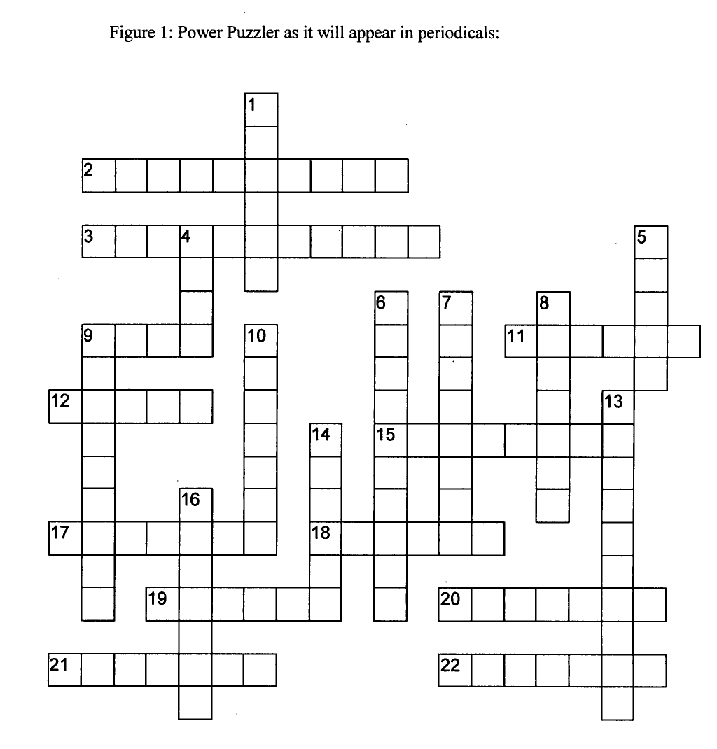

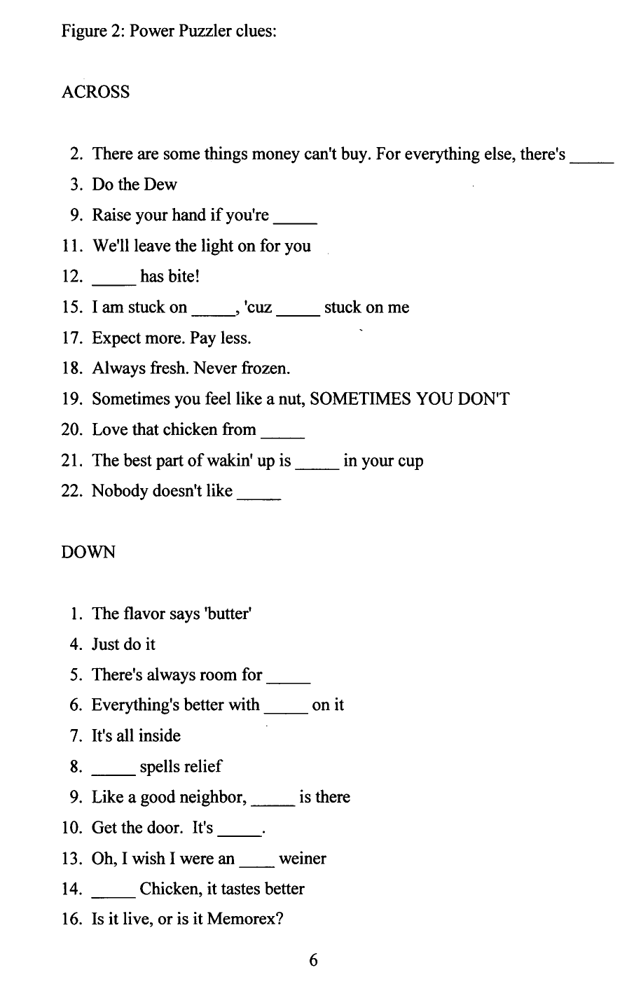

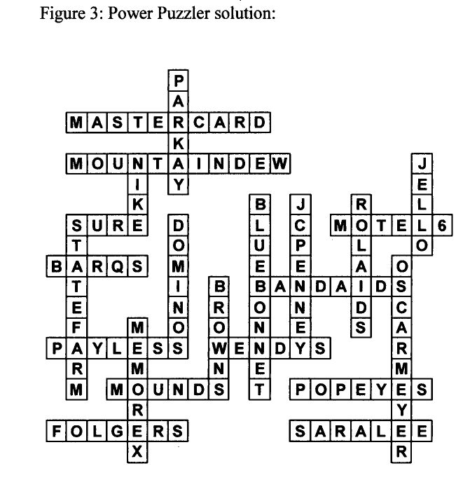

### DETAILED DESCRIPTION OF THE INVENTION

Power Puzzler is a standard crossword puzzle used solely for advertising purposes. Power Puzzler will be run in newspapers and magazines, as well as on the Power Puzzler website. It will attract both readers and surfers to the solution on the Power Puzzler website. There they will find other entertainment, and also see ads from advertisers, giving the brand names that advertise more exposure. All clues given will pertain to businesses that purchase advertising from Power Puzzler LLC, and no extraneous words or fillers will be used. When possible, pictures or excerpts of pictures from brands and products will be used in place of word clues. Companies may purchase one space in a crossword puzzle, or contract with us to create a puzzle themed for their brand name alone.

1. This patent is intended to cover using a crossword format for the sole purpose of advertising, and we expect the protection this patent would grant to cover any other inventor, entity or organization that attempts to use or copy our format for the purpose of advertising in any venue.
